(19) United States
(12) Patent Application Publication
(10) Pub. No.: US 2008/0174268 A1
(43) Pub. Date: Jul. 24, 2008

(54) Automatic charging apparatus of autonomous mobile robot and automatic charging method using the same

(76) Inventors: Keun Mo Koo, Myeong-si (KR); Kyung Chul Shin, Yangchun-gu (KR)

Correspondence Address: Thomas M. Galgano;Suite 204, 20 W. Park Avenue, Long Beach, NY, 11561, US

(21) Appl. No.: 12/005,225

(22) Filed: Dec. 26, 2007

(30) Foreign Application Priority Data
Dec. 27, 2006 (KR) 10-2006-0134743

(51) Int. Cl. H02J 7/00; B25J 19/00

(52) U.S. Cl. 320/109; 318/568.12; 318/568.16; 901/1

(57) ABSTRACT

Disclosed are an automatic charging apparatus of an autonomous mobile robot and an automatic charging method using the same in that a moving robot can automatically detect infrared signals emitted from a charging station and can automatically induce charging station so as to automatically charge a battery of the robot, whereby improving convenience thereof. The automatic charging apparatus of the autonomous mobile robot, comprises a charging station having connecting terminals for charging the battery and an infrared signal generator for emitting infrared signals on a position information thereof; and a moving robot having an infrared receiving apparatus for receiving the infrared signals from the infrared signal generator in a cast that a remnant capacity of the battery is insufficient or a charging order is inputted, a microcomputer for controlling a traveling of the moving robot by using a detected position information of the charging station through the infrared signals received from the infrared receiving apparatus, and charging terminals for charging the battery with electricity through the contact with the connecting terminal.

### BACKGROUND OF THE INVENTION

1. Field of the Invention

The present invention relates to an automatic charging apparatus of an autonomous mobile robot and an automatic charging method using the same, and more particularly to an automatic charging apparatus of an autonomous mobile robot and an automatic charging method using the same in that a moving robot can automatically detect infrared signals emitted from a charging station and can automatically induce charging station so as to automatically charge a battery of the robot, whereby improving convenience thereof.

2. Description of the Prior Art

Generally, a moving robot serves to conduct a specific working while travelling automatically. There are a cleaning robot and monitoring robot and so on. Recently, the field of the cleaning robot has formed a new market and has been enlarged in scale.

The general moving robot can serve to automatically perform the ordered working such as a cleaning working, monitoring working and so forth.

The conventional cleaning robot serves to automatically suck a dust or an external material while being automatically moved within a predetermined cleaning area.

The cleaning robot includes a vacuum cleaner part for sucking the dust or the external material, a travelling device for travelling the moving robot, a plurality of detecting sensors for detecting obstacles in order that the moving robot is not conflicted with various obstacles, and a microprocessor for controlling the battery for power and each device.

Accordingly, the clean robot can mark the distance between the robot and the obstacles such as various obstacles, for example furniture, wall and so on formed within the cleaning area, it can clean the cleaning area while being not conflicted with the obstacles by using the detected information.

If the cleaning robot has a battery for power, in case of an electric discharge of a battery thereof while at work, the user electrically should connect the moving robot to a separate charger in order to charge the battery of the moving robot.

However, there is a problem in that the conventional robot cannot automatically charge the battery thereof during his absence.

### SUMMARY OF THE INVENTION

Accordingly, the present invention has been made to solve the above-mentioned problems occurring in the prior art, and an object of the present invention is to provide an automatic charging apparatus of an autonomous mobile robot and an automatic charging method using the same in that a moving robot can automatically detect infrared signals emitted from a charging station and can automatically induce charging station so as to automatically charge a battery of the robot, whereby improving convenience thereof.

To accomplish the object, the present invention provides an automatic charging apparatus of an autonomous mobile robot supplied with a power by docking with a charging station in case of an electric discharge of a battery thereof while at work, comprising: a charging station having connecting terminals for charging the battery and an infrared signal generator for emitting infrared signals on a position information thereof; and a moving robot having an infrared receiving apparatus for receiving the infrared signals from the infrared signal generator in a cast that a remnant capacity of the battery is insufficient or a charging order is inputted, a microcomputer for controlling a traveling of the moving robot by using a detected position information of the charging station through the infrared signals received from the infrared receiving apparatus, and charging terminals for charging the battery with electricity through the contact with the connecting terminal.

Preferably, the infrared signal generator comprises a first infrared signal generating portion having a plurality of infrared light emitting diodes for minutely inducing the moving robot and formed inside a partition structure respectively in such a manner that the infrared signals thereof are not interfered with each other.

Preferably, the infrared signal generator comprises a first infrared signal generating portion having a plurality of infrared light emitting diodes for minutely inducing the moving robot and formed inside an infrared inducing pipe respectively in such a manner that the infrared signals thereof are not interfered with each other.

Preferably, the infrared signal generator comprises a second infrared signal generating portion having an infrared light emitting diode for a short distance for generating infrared signals toward a region adjacent to the charging station.

Preferably, the infrared receiving apparatus comprises a plurality of infrared inducing pipe formed inside a front, left and right side surface of the moving robot and a plurality of infrared receivers formed inside each of the infrared inducing pipes.

Preferably, the moving robot further comprises a remnant capacity detector of the battery for detecting the remnant capacity of the battery and an operating signal input portion for inputting an operating signal of a user and the microcomputer comprises a memory for storing an operating program for driving the moving robot and a standard value of the remnant capacity of the battery for driving the moving robot, a position detector for detecting the position of the charging station through the signals received by the infrared receiving apparatus, and a traveling controller for controlling the traveling of the moving robot according to the position information of the charging station inputted through the position detector.

To accomplish the object, the present invention provides an automatic charging method of an autonomous mobile robot, comprising the steps of: performing an operation of a moving robot according to an order of a user; judging a charging mode of a battery; rotating the moving robot from a stop position thereof so as to receive infrared signals from a charging station in case of charging mode; detecting a position of the charging station through the detected infrared signals, controlling a traveling of the moving robot according to the position information of the charging station, and placing the moving robot at a front portion of the charging station; and docking the moving robot with the charging station so as to automatically charge the a battery of the moving robot.

### BRIEF DESCRIPTION OF THE DRAWINGS

The above as well as the other objects, features and advantages of the present invention will be more apparent from the following detailed description taken in conjunction with the accompanying drawings, in which:

FIG. 1A is a front perspective view illustrating an automatic charging apparatus of an autonomous mobile robot according to one embodiment of the present invention;

FIG. 1B is a rear perspective view illustrating the autonomous mobile robot;

FIG. 1C is a front perspective view illustrating the autonomous mobile robot;

FIG. 2 is a perspective view illustrating an infrared receiving apparatus according to the present invention;

FIG. 3 is a block diagram illustrating an automatic charging apparatus of an autonomous mobile robot according to the present invention;

FIG. 4 is a schematic block diagram illustrating the infrared signal generator of FIG. 1A;

FIG. 5 is an enlarged perspective view illustrating a second infrared signal generating portion according to the present invention;

FIG. 6 illustrates a receiving range of the infrared signals according to the present invention;

FIG. 7 is a flow chart illustrating an automatic charging method of an autonomous mobile robot according to the present invention; and

FIG. 8 illustrates a receiving range of the infrared signals according to another embodiment of the present invention.

### DETAILED DESCRIPTION OF THE PREFERRED EMBODIMENTS

A preferred embodiment of the invention will be described in detail below with reference to the accompanying drawings.

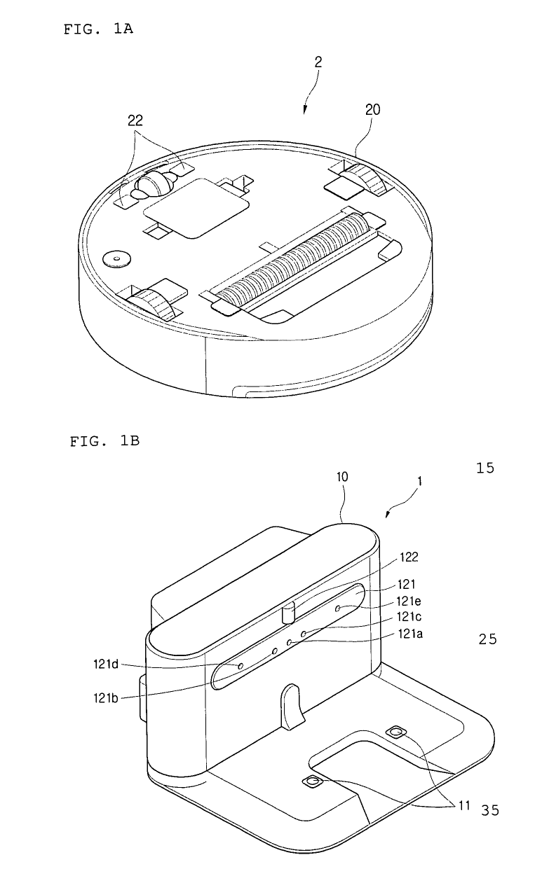

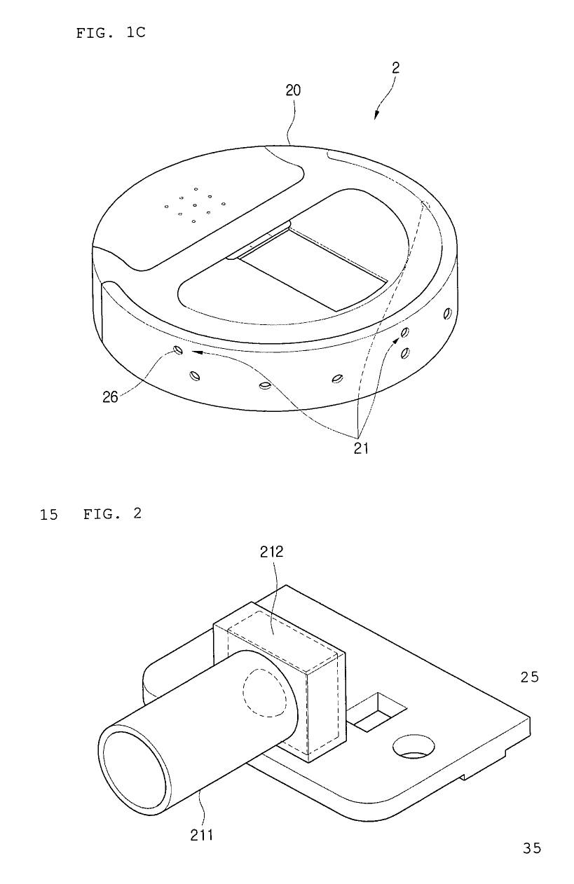

FIG. 1A is a front perspective view illustrating an automatic charging apparatus of an autonomous mobile robot according to one embodiment of the present invention, FIG. 1B is a rear perspective view illustrating the autonomous mobile robot, and FIG. 1C is a front perspective view illustrating the autonomous mobile robot.

Referring to FIG. 1A through FIG. 1C, the present invention relates to an automatic charging apparatus of an autonomous mobile robot supplied with the power by docking with a charging station in case of an electric discharge of a battery thereof while at work. The automatic charging apparatus of the autonomous mobile robot includes a charging station 1 and a moving robot 2.

The charging station 1 includes connecting terminals 11 and an infrared signal generator 12 formed at a body 10 thereof. The charging station 1 serves to induce the moving robot 2 through an emitting of the infrared signals and contact charging terminals of the moving robot 2 with the connecting terminals 11 through the docking with the induced moving robot 2 in order to charge the battery (not shown) built in the moving robot 2.

The infrared signal generator 12 includes a first infrared signal generating portion 121 having a plurality of infrared light emitting diodes (LEDs) 121a, 121b, 121c, 121d, and 121e for minutely inducing the moving robot 2. Preferably, the plurality of infrared light emitting diodes (LEDs) 121a, 121b, 121c, 121d, and 121e is arranged in such a manner that the signals thereof are not interfered with each other.

That is, in the infrared signal generator 12, the signals of the plurality of infrared light emitting diodes (LEDs) 121a, 121b, 121c, 121d, and 121e are interfered with each other according to the width of the beam thereof, so that the signals can be transmitted to an undesired area. Accordingly, in order to prevent this problem, it is preferred that each LED is formed inside a partition structure or an infrared inducing pipe.

In the meantime, the moving robot 2 includes an infrared receiving apparatus 21 for receiving the infrared signals from the plurality of infrared light emitting diodes (LEDs) 121a, 121b, 121c, 121d, and 121e in a cast that a remnant capacity of the battery formed at the inside of the body 20 of the moving robot 2 is insufficient or a charging order is inputted, a microcomputer (not shown) for controlling a traveling of the moving robot 2 by using a detected position information of the charging station through the signals received from the infrared receiving apparatus 21, and charging terminals 22 formed at the rear surface of the body 20 and corresponding to the connecting terminal 11 of the charging station 1 so as to charge the battery with electricity through the contact between them.

The infrared receiving apparatus 21 for receiving the infrared signals from the plurality of infrared light emitting diodes (LEDs) 121a, 121b, 121c, 121d, and 121e is fixed to the inside of front, left and right side portions of the body 20 of the moving robot 2 and is exposed to outside through a plurality of through holes 26 of a predetermined size.

FIG. 2 is a perspective view illustrating an infrared receiving apparatus according to the present invention.

As shown in FIG. 2, the infrared receiving apparatus 21 includes a plurality of infrared inducing pipe 211 formed at the inside of the through holes 26 and a plurality of infrared receivers 212 formed at the infrared inducing pipes 211. Here, the receiving range thereof can be controlled according to the control of the length of the infrared inducing pipe 211.

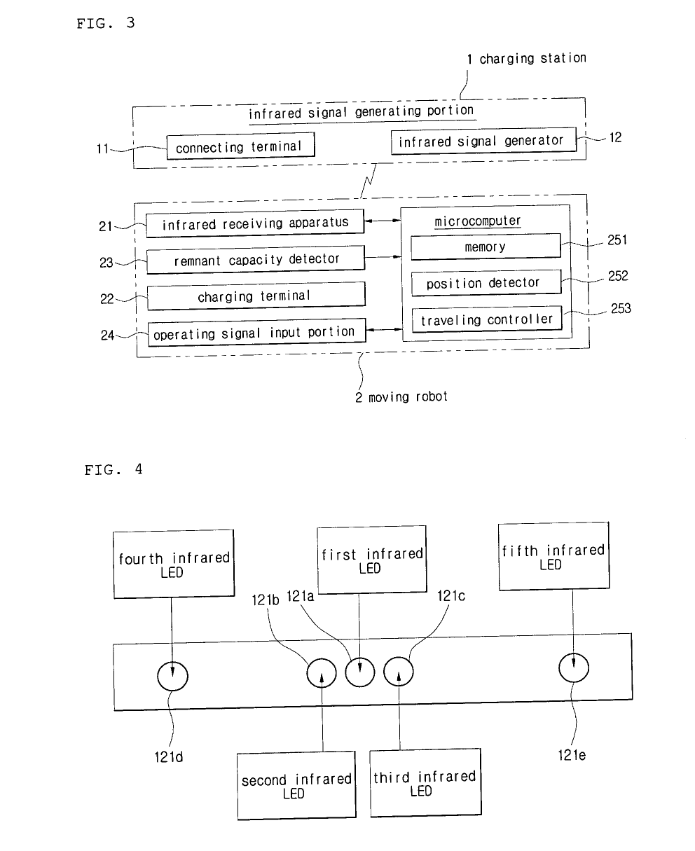

FIG. 3 is a block diagram illustrating an automatic charging apparatus of an autonomous mobile robot according to the present invention.

Also, as shown in FIG. 3, the moving robot 2 further includes a remnant capacity detector 23 of the battery for detecting the remnant capacity of the battery, an operating signal input portion 24 for inputting an operating signal of a user. Also, the microcomputer 25 includes a memory 251 for storing an operating program for driving the moving robot 2 and a standard value of the remnant capacity of the battery for driving the moving robot 2, a position detector 252 for detecting the position of the charging station 1 through the signals received by the infrared receiving apparatus 21, and a traveling controller 253 for controlling the traveling of the moving robot 2 according to the position information of the charging station 1 inputted through the position detector 252.

Here, the remnant capacity detector 23 of the battery can use a voltage detecting means for detecting a standard voltage value for driving the moving robot 2. Also, the traveling controller 253 serves to control the moving direction and moving speed.

FIG. 4 is a schematic block diagram illustrating the infrared signal generator of FIG. 1A.

As shown in FIG. 4, the infrared signal generator 12 includes the plurality of infrared light emitting diodes (LEDs) 121a, 121b, 121c, 121d, and 121e. Here, the plurality of infrared light emitting diodes (LEDs) 121a, 121b, 121c, 121d, and 121e can be distinguished from each other by means of on/off timing difference thereof.

Here, a first, second, and third infrared light emitting diodes 121a, 121b, and 121c serve to induce the moving robot 2 being a short distance away from the charging station 1. Accordingly, where the moving robot 2 is a short distance away from the charging station 1, since a minute inducement is required, the first, second, and third infrared light emitting diodes 121a, 121b, and 121c lie adjacent to each other.

The first infrared light emitting diode 121a is formed at a front central portion of the charging station 1 and the second and third infrared light emitting diodes 121b and 121c are arranged both sides of the first infrared light emitting diode 121a.

The fourth infrared light emitting diode 121d is formed at a left portion of the charging station 1 and the fifth infrared light emitting diodes 121e is arranged at a right portion of the charging station 1.

Here, the emittance of the inducing signals of each of the infrared light emitting diodes (LEDs) 121a, 121b, 121c, 121d, and 121e can be properly controlled according the inducing range such as a short or long distance inducement.

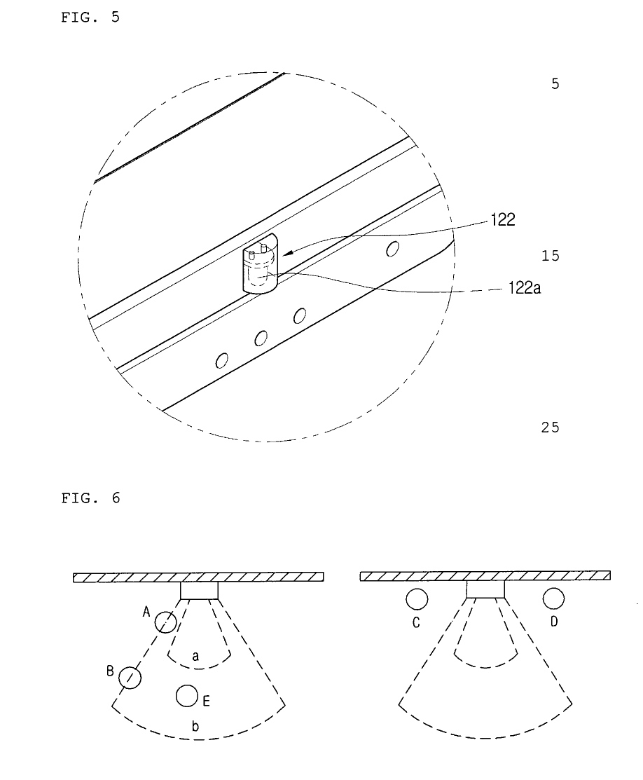

FIG. 5 is an enlarged perspective view illustrating a second infrared signal generating portion according to the present invention.

As shown in FIG. 5, the infrared signal generator 12 further includes a second infrared signal generating portion 122 having an infrared light emitting diode for a short distance for generating infrared signals toward a region adjacent to the charging station 1.

That is, as shown in FIG. 6, where the moving robot 2 is located toward the front portion of the charging station 1 at a sufficient inducing distance such as “B” or “E” point, the inducement of the moving robot 2 is easy. On the contrary, where the moving robot 2 is located at “C” or “D” point, since it is difficult to receive the inducing signals, although the moving robot 2 lies adjacent to the charging station 1, it is hard for the moving robot 2 to dock with the charging station 1.

Also, where the moving robot 2 lies closely adjacent to the charging station 1 such as “A” point, since it is hard for the moving robot 2 to dock with the charging station 1, the moving robot is moved to the “E” point and then, the moving robot 2 should be docked with the charging station 1.

In this case, as shown in FIG. 5, inducing signals emitted from the second infrared signal generating portion 122 having the infrared light emitting diode 122a for a short distance mounted reversely thereon can be generated, so that the moving robot 2 lain adjacent to the charging station 1 can receive the inducing signals.

That is, when the moving robot 2 detects the inducing signals emitted from the second infrared signal generating portion 122, it means that the charging station 1 lies adjacent to the moving robot 2.

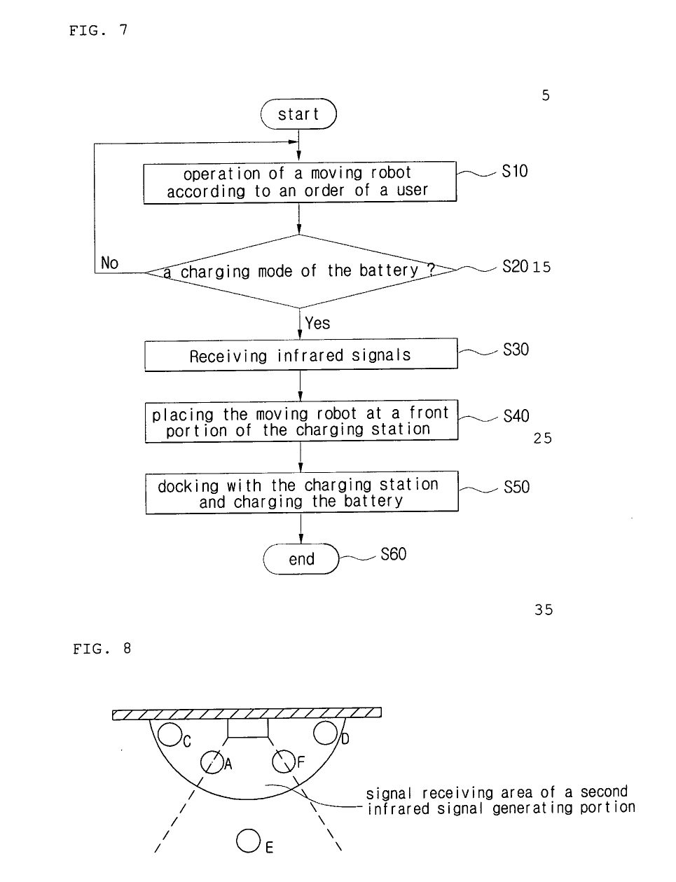

The automatic charging method using the automatic charging apparatus of the autonomous mobile robot will be described below with reference to FIG. 7.

FIG. 7 is a flow chart illustrating an automatic charging method of an autonomous mobile robot according to the present invention.

As shown in FIG. 7, the automatic charging method of the autonomous mobile robot according to the present invention includes steps of performing an operation of the moving robot 2 according to an order of a user (S10), judging a charging mode of the battery (S20), rotating the moving robot 2 from a stop position thereof so as to receive infrared signals from a charging station 1 in case of charging mode (S30), detecting a position of the charging station 1 through the detected infrared signals, controlling a traveling of the moving robot 2 according to the position information of the charging station 1, and placing the moving robot at a front portion of the charging station 1 (S40), and docking the moving robot 2 with the charging station 1 so as to automatically charge a battery of the moving robot 2 (S50).

Here, in the judging step S20 of the charging mode, in a cast that the remnant capacity of the battery is insufficient or a charging order is inputted by the user, insufficient remnant capacity signals of the battery or charging order signals are detected, so that it judges the signals as a charging mode.

More concretely, the automatic charging method using the automatic charging apparatus of the autonomous mobile robot will be described in detail below with reference to FIG. 6 and FIG. 8.

Firstly, it determines “yes” or “no” of the charging mode by detecting the remnant capacity of the battery or by judging whether the charging order of the user is inputted or not. Here, the detection of the remnant capacity of the battery can be performed through the detection of the battery voltage. That is, if the detected battery voltage is below the standard voltage value stored in the memory 251, it corresponds to the charging mode.

Continuously, in case of the charging mode, the moving robot 2 stops the performance working and then, is rotated from the stop position so as to receive the infrared signals from the infrared signal generator 12 of the charging station 1 through the infrared receiving apparatus 21 of the moving robot 2. Also, it can detect the comparative position of the charging station 1 through the position detector 252.

In this case, the position detector 252 can detect the approximate position of the charging station 1 through the inducing signals emitted from the infrared light emitting diodes 121 and 122. Here, where the inducing signal is not detected, the moving robot 2 can be moved through a random movement or a wall-following manner and so on until the inducing signal is detected.

Then, when it detects the comparative position of the charging station 1, the moving robot 2 can be appropriately removed to the charging station 1 according to the inducing signals emitted from the infrared light emitting diodes. Here, where the moving robot 2 gets near to the charging station 1, the moving robot 2 decreases the speed and travels delicately.

For example, where the moving robot 2 detects only the inducing signal of the fourth infrared light emitting diode 121d at “B” point, the rotation speed of the left wheel thereof is increased while decreasing that of the right wheel, so that the traveling direction thereof is changed toward the right side. On the contrary, if the moving robot 2 detects only the inducing signal of the fifth infrared light emitting diode 121e, the traveling direction thereof is changed toward the left side. Also, when the moving robot 2 detects the inducing signals of the fourth and fifth infrared light emitting diodes 121d and 121e, the moving robot 2 goes straight ahead so as to approach to the charging station 1.

Here, in a case that the moving robot 2 is approached to the charging station 1, the moving robot 2 can detect the inducing signals from another infrared light emitting diode. Also, where the moving robot 2 is located at “a” area, the moving speed thereof becomes lower in comparison with “b” area in order to minutely travel the moving robot 2. At this time, when the moving robot 2 detects the inducing signal of the first infrared light emitting diode 121a, it goes straight ahead. Here, where the robot 2 went straight ahead detects the inducing signal of the second infrared light emitting diode 121b, the traveling direction thereof is changed toward the right side. Also, when the moving robot 2 detects the inducing signal of the third infrared light emitting diode 121c, the moving robot 2 is changed toward the left side.

Accordingly, where the moving robot 2 is located toward the front portion of the charging station 1 at a sufficient inducing distance, the moving robot 2 can be advanced into the charging station 1 at right angles.

However, where the moving robot 2 is located at “C” or “D” point, since it is difficult to receive the inducing signals, although the moving robot 2 lies adjacent to the charging station 1, it is hard for the moving robot 2 to dock with the charging station 1.

Also, in case of “A” point, it forms the same boundary with “B” point. However, since the moving robot 2 lies closely adjacent to the charging station 1, the moving robot is moved to the “E” point and then, the moving robot 2 should be docked with the charging station 1.

In order to solve this problem, the inducing signals emitted from the second infrared signal generating portion 122 and the fourth infrared light emitting diode 121d can be generated. In this case, the moving robot 2 is rotated in the direction of a right-handed screw until the infrared inducing signal is not received to the left infrared receiver and then, goes straight ahead at a sufficient distance to be moved to “E” point.

For example, in case of “F” point (note FIG. 8), the inducing signals emitted from the second infrared signal generating portion 122 and the fifth infrared light emitting diode 121e can be received. In this case, the moving robot 2 can be rotated counterclockwise until the infrared inducing signal is not received to the right infrared receiver and then, goes straight ahead at a sufficient distance to be moved to “E” point.

Also, where the moving robot 2 is located at “C” or “D” point (note FIG. 6), only the inducing signal emitted from the second infrared signal generating portion 122 can be received. In this case, the moving robot 2 can be rotated at right angles and then, goes straight ahead at a sufficient distance.

Here, in case of “C” point, since the moving robot 2 faces the wall within a predetermined distance, it can confirm that the moving robot 2 is located at “C” point. Accordingly, the moving robot 2 can be rotated 180-degree and then, goes straight ahead at a sufficient distance to be moved to “E” point. Finally, the moving robot moved to “E” point is docked with the charging station 1 through the vertical entry to automatically charge the storage battery.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

As can be seen from the foregoing, in the automatic charging apparatus of an autonomous mobile robot and an automatic charging method using the same, the moving robot can automatically detect infrared signals emitted from a charging station and can automatically induce charging station, so that it can detect the comparative position information and then, the moving direction and the travelling speed can be minutely controlled in such a manner that the moving robot is located at the front side of the charging station so as to automatically charge a battery of the robot, whereby improving convenience thereof.

What is claimed is:

1. An automatic charging apparatus of an autonomous mobile robot supplied with a power by docking with a charging station in case of an electric discharge of a battery thereof while at work, comprising:
a charging station having connecting terminals for charging the battery and an infrared signal generator for emitting infrared signals on a position information thereof; and
a moving robot having an infrared receiving apparatus for receiving the infrared signals from the infrared signal generator in a cast that a remnant capacity of the battery is insufficient or a charging order is inputted, a microcomputer for controlling a traveling of the moving robot by using a detected position information of the charging station through the infrared signals received from the infrared receiving apparatus, and charging terminals for charging the battery with electricity through a contact with the connecting terminal.

2. An automatic charging apparatus of an autonomous mobile robot as claimed in claim 1, wherein the infrared signal generator comprises a first infrared signal generating portion having a plurality of infrared light emitting diodes for minutely inducing the moving robot and formed inside a partition structure respectively in such a manner that the infrared signals thereof are not interfered with each other.

3. An automatic charging apparatus of an autonomous mobile robot as claimed in claim 1, wherein the infrared signal generator comprises a first infrared signal generating portion having a plurality of infrared light emitting diodes for minutely inducing the moving robot and formed inside an infrared inducing pipe respectively in such a manner that the infrared signals thereof are not interfered with each other.

4. An automatic charging apparatus of an autonomous mobile robot as claimed in claim 3, wherein the infrared signal generator comprises a second infrared signal generating portion having an infrared light emitting diode for a short distance for generating infrared signals toward a region adjacent to the charging station.

5. An automatic charging apparatus of an autonomous mobile robot as claimed in claim 1, wherein the infrared receiving apparatus comprises a plurality of infrared inducing pipe formed inside a front, left and right side surface of the moving robot and a plurality of infrared receivers formed inside each of the infrared inducing pipes.

6. An automatic charging apparatus of an autonomous mobile robot as claimed in claim 1, wherein the moving robot further comprises a remnant capacity detector of the battery for detecting the remnant capacity of the battery and an operating signal input portion for inputting an operating signal of a user and the microcomputer comprises a memory for storing an operating program for driving the moving robot and a standard value of the remnant capacity of the battery for driving the moving robot, a position detector for detecting the position of the charging station through the signals received by the infrared receiving apparatus, and a traveling controller for controlling the traveling of the moving robot according to the position information of the charging station inputted through the position detector.

7. An automatic charging method of an autonomous mobile robot, comprising the steps of:
performing an operation of a moving robot according to an order of a user;
judging a charging mode of a battery;
rotating the moving robot from a stop position thereof so as to receive infrared signals from a charging station in case of charging mode;
detecting a position of the charging station through the detected infrared signals, controlling a traveling of the moving robot according to the position information of the charging station, and placing the moving robot at a front portion of the charging station; and
docking the moving robot with the charging station so as to automatically charge the a battery of the moving robot.
